(19) United States
(12) Patent Application Publication
(10) Pub. No.: US 2025/0355333 A1
(43) Pub. Date: Nov. 20, 2025

(54) PHOSPHOR WHEEL AND METHOD FOR PRODUCING THE SAME

(71) Applicant: PANASONIC HOLDINGS CORPORATION, Osaka (JP)

(72) Inventors: Shoichi KAWAMITSU, Osaka (JP); Takashi IKEDA, Osaka (JP); Yusaku NISHIKAWA, Osaka (JP)

(21) Appl. No.: 19/284,013

(22) Filed: Jul. 29, 2025

Related U.S. Application Data
(63) Continuation of application No. PCT/JP2024/001301, filed on Jan. 18, 2024.

(30) Foreign Application Priority Data
Jan. 31, 2023 (JP) 2023-012948

(51) Int. Cl. G03B 21/20; C09K 11/02; C09K 11/77

(52) U.S. Cl. CPC G03B 21/204; C09K 11/025; C09K 11/7774

(57) ABSTRACT

A phosphor wheel including a binder excellent in thermal conduction properties is provided. A phosphor wheel includes: a substrate; an intermediate layer provided on the substrate, the intermediate layer being made of a first binder; and a phosphor layer provided on the intermediate layer, the phosphor layer including a second binder and a phosphor included in the second binder, wherein at least one of the first binder and the second binder contains polysilsesquioxane.

### CROSS REFERENCE TO RELATED APPLICATION

This application claims priorities of Japanese Patent Application No. 2023-12948 filed on Jan. 31, 2023 and PCT Application No. PCT/JP2024/001301 filed on Jan. 18, 2024, the contents of which are incorporated herein by reference.

### BACKGROUND

### 1. Technical Field

The present disclosure relates to, for example, a phosphor wheel used for a light source device of a projection-type image display apparatus, and a method for producing the phosphor wheel.

### 2. Description of the Related Art

Conventionally, as a high-output-compatible phosphor wheel, there has been used a phosphor wheel including a phosphor layer and an intermediate layer (reflection layer) using silicone resin as a binder as shown in JP 2013-228598A1 (Patent Document 1).

### SUMMARY

However, the silicone resin used as the binder has low thermal conduction properties and poor heat dissipation. Thus, it may cause temperature quenching of the phosphor. In addition, when the intensity of incident light on the phosphor wheel is increased along with an increase in output, the temperature may rise to a threshold value of the binder or more, leading to alteration of the organic component.

The present disclosure is intended to solve the above-mentioned conventional problems, and one non-limiting and exemplary embodiments provides a phosphor wheel including a binder excellent in thermal conduction properties.

In one general aspect, the techniques disclosed here feature: a phosphor wheel includes:
a substrate;
an intermediate layer provided on the substrate, the intermediate layer being made of a first binder; and
a phosphor layer provided on the intermediate layer, the phosphor layer comprising a second binder and a phosphor included in the second binder,
wherein at least one of the first binder and the second binder contains polysilsesquioxane.

In another general aspect, the techniques disclosed here feature: a method for producing a phosphor wheel, the method includes:
providing a substrate;
providing an intermediate layer made of a first binder on the substrate; and
providing a phosphor layer comprising a second binder and a phosphor included in the second binder on the intermediate layer,
wherein at least one of the first binder and the second binder contains polysilsesquioxane.

According to the phosphor wheel of the present disclosure, at least one of the first binder and the second binder contained in the phosphor layer or the intermediate layer contains polysilsesquioxane. This can improve the thermal conduction properties of at least one of the first binder and the second binder.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF THE DRAWINGS

The present disclosure will become readily understood from the following description of non-limiting and exemplary embodiments thereof made with reference to the accompanying drawings, in which like parts are designated by like reference numeral and in which:

FIG. 1 is a schematic perspective view showing an overview of a phosphor wheel according to a first embodiment,

FIG. 2 is a schematic plan view showing a plane configuration of a phosphor wheel according to the first embodiment,

FIG. 3 is a schematic sectional view showing a sectional structure of the phosphor wheel of FIG. 2 as viewed in the A-A direction,

FIG. 4 is a diagram showing a structural formula showing an example of the structure of polysilsesquioxane,

FIG. 5 is a diagram showing a structural formula of dimethyldialkoxysilane which is an organosilicon compound having a reactive bifunctional group,

FIG. 6 is a diagram showing a structural formula of a polymer obtained by polymerizing the dimethyldialkoxysilane of FIG. 5,

FIG. 7 is a diagram showing a structural formula of dimethyldihydroxysilane which is an organosilicon compound having a reactive bifunctional group,

FIG. 8 is a diagram showing a structural formula of a polymer obtained by polymerizing the dimethyldihydroxysilane of FIG. 7,

FIG. 9 is a diagram showing a configuration of a light source device using a phosphor wheel according to modification 1 of the first embodiment,

FIG. 10 is a diagram showing a configuration of a projection-type image display apparatus equipped with the light source device using the phosphor wheel according to modification 1 of the first embodiment,

FIG. 11 is a diagram showing a configuration of a light source device using a phosphor wheel according to modification 2 of the first embodiment,

FIG. 12 is a diagram showing a configuration of a projection-type image display apparatus equipped with the light source device using the phosphor wheel according to modification 2 of the first embodiment, and

FIG. 13 is a graph showing a relationship between an excitation light density and a temperature at the time of laser light irradiation from a laser light source in light source devices using phosphor wheels according to examples 1 and 2 of the first embodiment and a comparative example.

### DETAILED DESCRIPTION

A phosphor wheel according to a first aspect, includes:
a substrate;
an intermediate layer provided on the substrate, the intermediate layer being made of a first binder; and
a phosphor layer provided on the intermediate layer, the phosphor layer comprising a second binder and a phosphor included in the second binder,
wherein at least one of the first binder and the second binder contains polysilsesquioxane.

In the phosphor wheel according to a second aspect in addition to the first aspect, the first binder contains silicone resin, and the second binder contains polysilsesquioxane.

In the phosphor wheel according to a third aspect in addition to the first or second aspect, the first binder or the second binder containing the polysilsesquioxane contains an organosilicon compound having a reactive bifunctional group in an amount of 50 wt % or less with respect to 100 wt % of the polysilsesquioxane contained in the first binder or the second binder.

In the phosphor wheel according to a fourth aspect in addition to the third aspect, the first binder or the second binder containing the polysilsesquioxane contains the organosilicon compound having a reactive bifunctional group in an amount of 30 wt % or less with respect to 100 wt % of the polysilsesquioxane contained in the first binder or the second binder.

In the phosphor wheel according to a fifth aspect in addition to any one of the first to fourth aspect, the second binder contains polysilsesquioxane, and the first binder contains polysilsesquioxane and an organosilicon compound having a reactive bifunctional group in an amount of 50 wt % or less with respect to 100 wt % of the polysilsesquioxane contained in the first binder and the second binder.

In the phosphor wheel according to a sixth aspect in addition to any one of the first to fifth aspect, the second binder contains polysilsesquioxane, and the first binder contains polysilsesquioxane and an organosilicon compound having a reactive bifunctional group in an amount of 30 wt % or less with respect to 100 wt % of the polysilsesquioxane contained in the first binder and the second binder.

In the phosphor wheel according to a seventh aspect in addition to any one of the first to sixth aspect, the first binder and the second binder contain polysilsesquioxane.

A light source device according to an eighth aspect includes the phosphor wheel according to any one of the first to seventh aspect.

In the light source device according to nineth aspect in addition to eighth aspect, further includes a laser light source having an excitation light density of 30 W/mm² or more.

A projection-type image display device according to tenth aspect, includes the light source device according to the eighth or nineth aspect.

A method for producing a phosphor wheel according to eleventh aspect, the method includes:
providing a substrate;
providing an intermediate layer made of a first binder on the substrate; and
providing a phosphor layer comprising a second binder and a phosphor included in the second binder on the intermediate layer,
wherein at least one of the first binder and the second binder contains polysilsesquioxane.

Hereinafter, embodiments will be described in detail with reference to the drawings. Unnecessarily detailed description may be omitted. For example, a detailed description of a well-known matter and a repeated description of substantially the same configuration may be omitted. This is to avoid unnecessary redundancy of the following description and to facilitate understanding of the skilled person. Substantially the same members in the drawings are denoted by the same reference numerals.

The accompanying drawings and the following description are provided for the skilled person to fully understand the present disclosure, and they are not intended to limit the subject matter described in the claims.

### First Embodiment

### [1-1 Configuration of Phosphor Wheel]

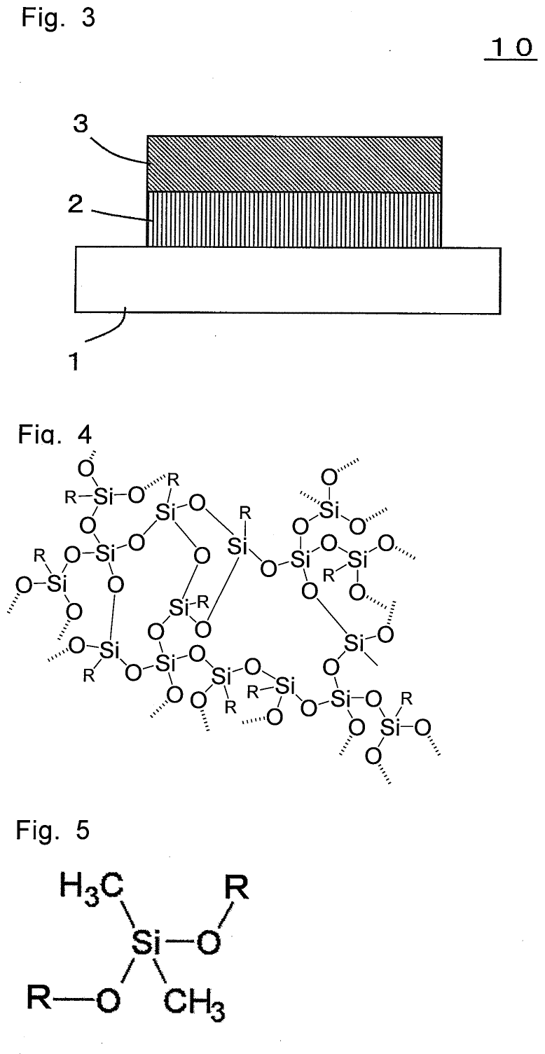

Hereinafter, a configuration of a phosphor wheel 10 according to a first embodiment will be described in detail. FIG. 2 is a schematic plan view showing a plane configuration of the phosphor wheel 10 according to the first embodiment. FIG. 3 is a schematic sectional view showing a sectional structure of the phosphor wheel 10 of FIG. 2 as viewed in the A-A direction.

The phosphor wheel 10 according to the first embodiment includes a substrate 1, an intermediate layer 2 provided on the substrate 1, and a phosphor layer 3 provided on the intermediate layer 2. The intermediate layer 2 is made of a first binder, and the phosphor layer 3 contains a second binder and a phosphor included in the second binder. At least one of the first binder and the second binder contains polysilsesquioxane.

This can improve the thermal conduction properties of at least one of the first binder and the second binder. For example, the heat dissipation is improved by approximately 20% as compared with a case where all of the first and second binders are made of silicone resin.

Hereinafter, members constituting the phosphor wheel 10 will be described.

### <Substrate>

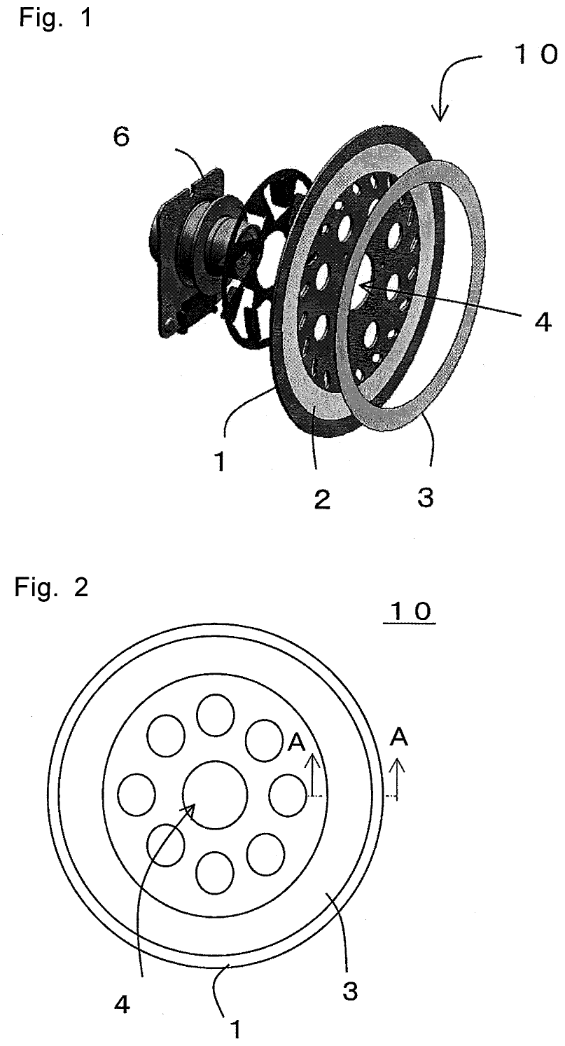

The substrate 1 may be, for example, a rotatable substrate. The substrate 1 may have, for example, a disk shape. Alternatively, it may have a polygonal shape. The substrate 1 may be, for example, a substrate made of aluminum having excellent heat dissipation. The substrate is not limited to aluminum but may be made of another metal. The substrate may be a transmissive or transparent substrate such as glass or sapphire, or may be a transmissive or transparent substrate such as glass or sapphire provided with a reflection region. As shown in FIGS. 1 and 2, the substrate 1 may be provided with a motor mounting hole 4 for mounting a motor 6 for rotation. Also, the motor 6 may be attached to the substrate by using a method other than the mounting hole 4.

### <Intermediate Layer (First Binder)>

The intermediate layer 2 is provided between the phosphor layer 3 and the substrate 1 and serves as a stress relieving layer. The intermediate layer 2 may have a function as a reflection layer. That is, light incident on the phosphor layer 3 may be reflected by the intermediate layer 2. The intermediate layer 2 is made of the first binder.

When the intermediate layer 2 has a function as a reflection layer, for example, the intermediate layer 2 may further include titanium oxide contained in the first binder.

The first binder may be, for example, silicone resin, epoxy resin, or polysilsesquioxane (FIG. 4).

The intermediate layer may have a thickness of, for example, 10 μm or more and 200 μm or less.

As polysilsesquioxane, a random structure (FIG. 4), a ladder structure, a cage structure, and the like are known, and any structure may be used. Among the above, a random structure and a ladder structure are preferable. Further, a random structure as shown in FIG. 4 is more preferable. Polysilsesquioxane has a relatively high thermal conductivity of 0.3 W/mK as compared with silicone resin (thermal conductivity: 0.1 W/mK) and can obtain excellent thermal conduction properties.

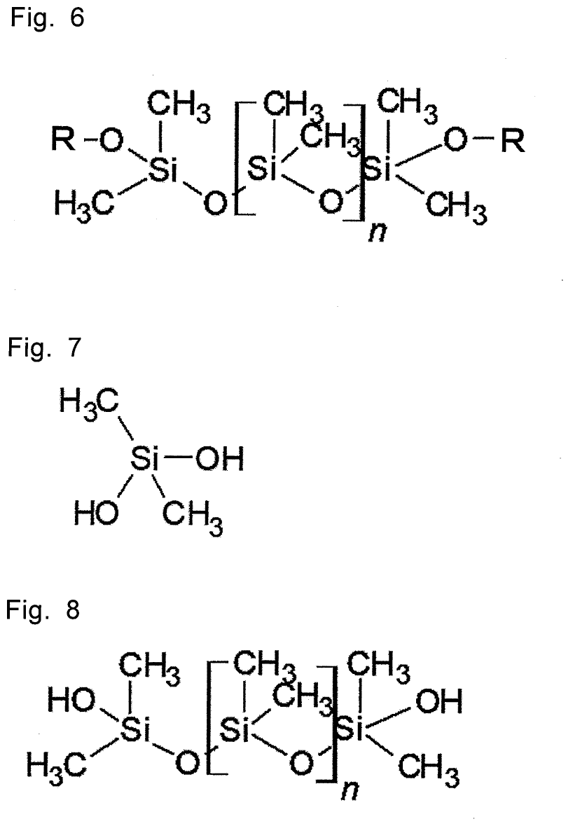

When the first binder has polysilsesquioxane, the first binder may further contain an organosilicon compound having a reactive bifunctional group. The organosilicon compound having a reactive bifunctional group may be, for example, at least one selected from dialkoxydimethylsilane whose structural formula is shown in FIG. 5 as an example, dimethyldihydroxysilane whose structural formula is shown in FIG. 7 as an example, and a compound or a polymer in which a carbon-number n has a value of 0 or more among compounds whose structural formulas are shown in FIGS. 6 and 8 as examples. A functional group R in FIGS. 5 and 6 may be, for example, an alkyl group such as a methyl group, an ethyl group, or a propyl group, or an alkoxy group such as a methoxy group or an ethoxy group. When the organosilicon compound having a reactive bifunctional group is contained in an amount of a range of 5 wt % or more and 50 wt % or less, further in an amount of a range of 10 wt % or more and 30 wt % or less, with respect to 100 wt % of polysilsesquioxane, such that silsesquioxane can be modified, and the generation of cracks can be suppressed.

For example, as conditions for curing and film formation of a polysilsesquioxane mixture, a film can be formed at 100° C. to 300° C. for 1 hour to 4 hours in an air atmosphere. Alternatively, it can be cured at room temperature by using a titanium-based or aluminum-based curing catalyst.

### <Phosphor Layer>

The phosphor layer includes a second binder and a phosphor contained in the second binder.

### <Phosphor>

The phosphor may be, for example, particles having a garnet crystal structure. The chemical formula of the garnet crystal structure may be, for example, Y₃Al₅O₁₂ that wavelength-converts blue excitation light into yellow fluorescence or Lu₃Al₅O₁₂ that wavelength-converts blue excitation light into green fluorescence. Alternatively, the phosphor may be (Y,Lu)₃Al₅O₁₂, which is a mixture thereof. The activator element may be, for example, Ce or Gd. The phosphor may be in particulate form that may convert blue excitation light into fluorescence other than yellow or green described above. As the phosphor, a red phosphor such as (Sr,Ca)AlSiN₃:Eu²⁺ or CaAlSiN₃:Eu²⁺ may be used. The wavelength to be wavelength-converted can be variously changed by changing the structure, composition, and the like.

The phosphor layer may have a thickness of, for example, 70 μm or more and 300 μm or less.

### <Second Binder>

The second binder is a medium in which a phosphor is dispersed, and it may be, for example, heat-resistant transparent resin, such as silicone resin or polysilsesquioxane, or glass such as silicon dioxide or silicate glass.

As polysilsesquioxane, a random structure (FIG. 4), a ladder structure, a cage structure, and the like are known, and any structure may be used. Among the above, a random structure and a ladder structure are preferable. Further, a random structure as shown in FIG. 4 is more preferable. Polysilsesquioxane has a relatively high thermal conductivity of 0.3 W/mK as compared with silicone resin (thermal conductivity: 0.1 W/mK) and can obtain excellent thermal conduction properties.

When the second binder has polysilsesquioxane, the second binder may further contain an organosilicon compound having a reactive bifunctional group. The organosilicon compound having a reactive bifunctional group may be, for example, at least one selected from dialkoxydimethylsilane whose structural formula is shown in FIG. 5 as an example, dimethyldihydroxysilane whose structural formula is shown in FIG. 7 as an example, and a compound or a polymer in which a carbon-number n has a value of 0 or more among compounds whose structural formulas are shown in FIGS. 6 and 8 as examples. A functional group R in FIGS. 5 and 6 may be, for example, an alkyl group such as a methyl group, an ethyl group, or a propyl group, or an alkoxy group such as a methoxy group or an ethoxy group. When the organosilicon compound having a reactive bifunctional group is contained in an amount of a range of 5 wt % or more and 50 wt % or less, preferably, in an amount of a range of 10 wt % or more and 30 wt % or less, with respect to 100 wt % of polysilsesquioxane, such that silsesquioxane can be modified, and the generation of cracks can be suppressed.

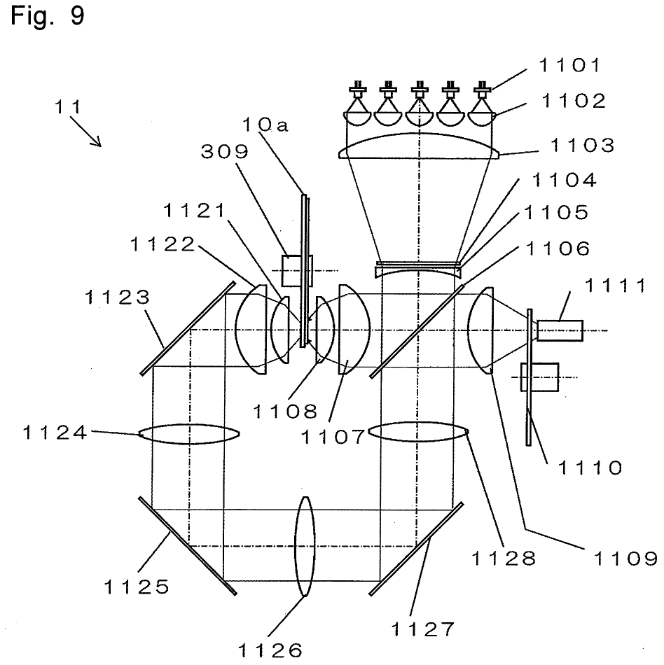

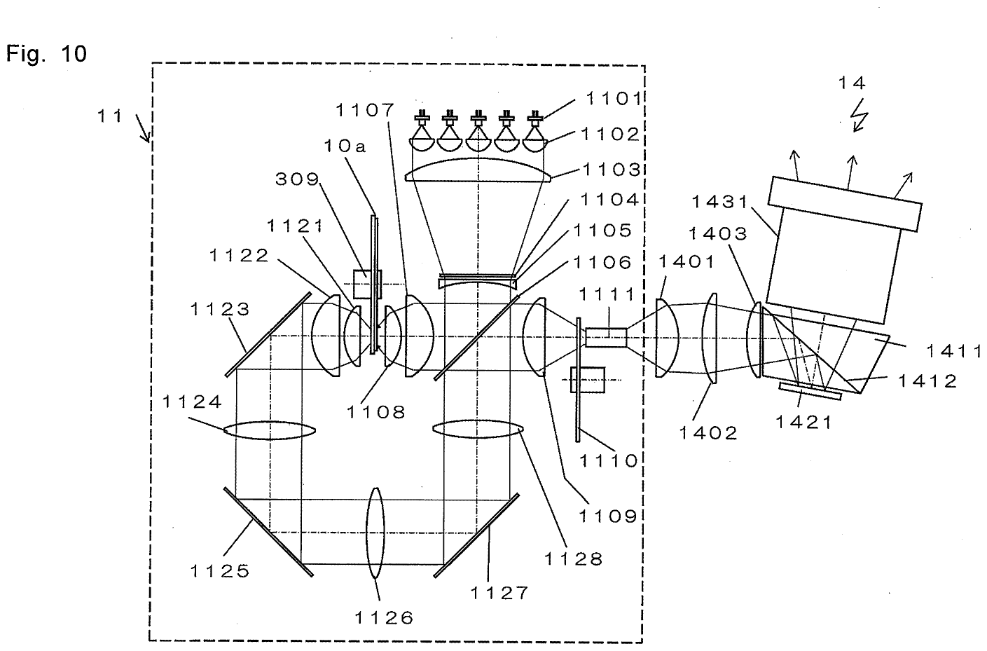

The intermediate layer 2 and the phosphor layer 3 may be provided circumferentially with respect to the rotation center, for example, as shown in FIGS. 1 and 2. Further, for example, in a phosphor wheel (FIG. 9, FIG. 10) of modification 1, an opening may be provided in a part of the circumference of the substrate 1. In the phosphor wheel according to modification 1, the excitation light incident on the phosphor wheel can be transmitted as it is. One or more openings may be provided.

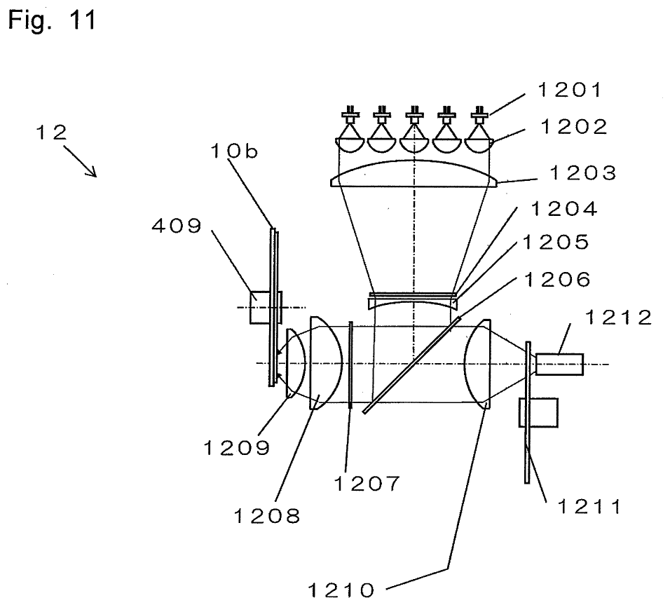

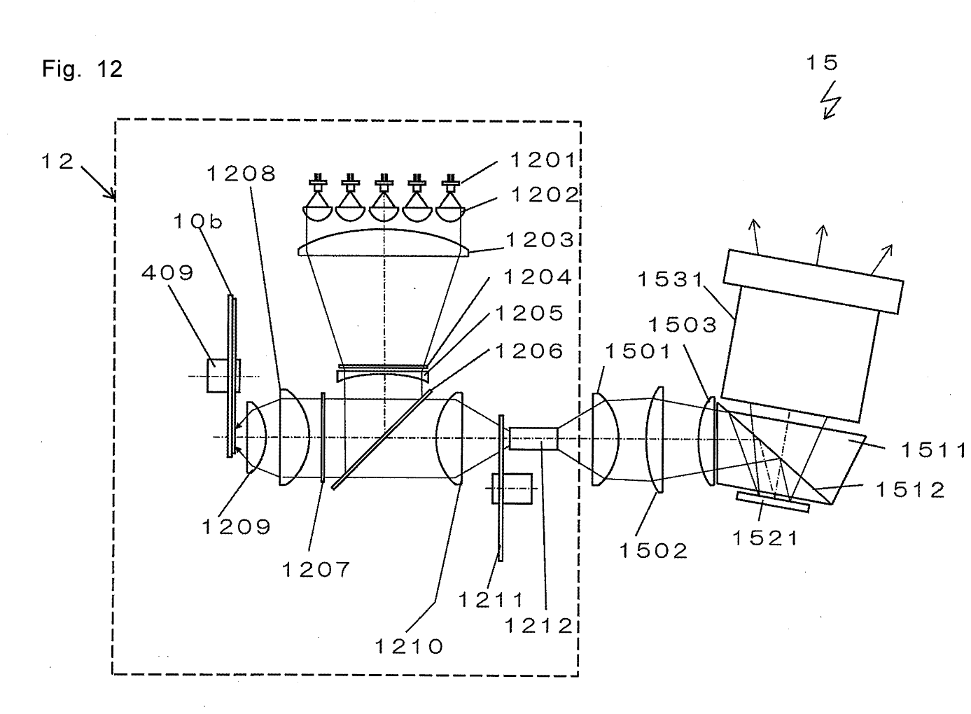

In a phosphor wheel (FIG. 11, FIG. 12) according to modification 2, there may be provided a portion where only an intermediate layer having the function of a reflection layer is provided and no phosphor layer is provided on a part of the circumference. This can reflect the incident excitation light as it is with the intermediate layer that is a reflection layer. One or more portions may be provided where only the intermediate layer that is a reflection layer is provided and no phosphor layer is provided.

### [Method for Producing Phosphor Wheel]

The method for producing the phosphor wheel according to the first embodiment includes the following steps.
(1) The substrate 1 is provided (S01). The substrate 1 has a disk shape, for example, and it may be a substrate made of aluminum having excellent heat dissipation.
(2) The first binder is provided onto the substrate 1 to form the intermediate layer 2 (S01). The first binder may be, for example, silicone resin, epoxy resin, or polysilsesquioxane (FIG. 4). When the first binder has polysilsesquioxane, the first binder may contain an organosilicon compound having a reactive bifunctional group. The organosilicon compound having a reactive bifunctional group may be, for example, at least one selected from diethoxydimethylsilane, dimethyldihydroxysilane, and polymers thereof. When the organosilicon compound having a reactive bifunctional group is contained in an amount of a range of 5 wt % or more and 50 wt % or less, further, in an amount of a range of 10 wt % or more and 30 wt % or less, with respect to polysilsesquioxane, silsesquioxane can be modified, and the generation of cracks can be suppressed.
(3) The phosphor layer 3 in which a phosphor is dispersed in a second binder is provided onto the intermediate layer 2 (S03). The second binder is a medium in which a phosphor is dispersed, and it may be, for example, heat-resistant transparent resin, such as silicone resin or polysilsesquioxane, or glass such as silicon dioxide or silicate glass. When the second binder has polysilsesquioxane, it is preferable that the second binder contains an organosilicon compound having a reactive bifunctional group. The organosilicon compound having a reactive bifunctional group may be, for example, at least one selected from diethoxydimethylsilane, dimethyldihydroxysilane, and polymers thereof. When the organosilicon compound having a reactive bifunctional group is contained in an amount of a range of 5 wt % or more and 50 wt % or less, preferably, in an amount of a range of 10 wt % or more and 30 wt % or less, with respect to polysilsesquioxane, such that silsesquioxane can be modified, and the generation of cracks can be suppressed.

The phosphor wheel 10 according to the first embodiment is obtained through the above steps.

Different layers may be further provided between the substrate 1 and the intermediate layer 2, between the intermediate layer 2 and the phosphor layer 3, and on the phosphor layer 3.

### Example 1

A phosphor wheel according to example 1 includes a substrate made of aluminum, an intermediate layer, and a phosphor layer, which are sequentially stacked on the substrate. The intermediate layer has a function as a reflection layer. The intermediate layer was formed by using polysilsesquioxane as the first binder and by dispersing titanium oxide TiO₂ in the first binder. The phosphor layer was formed by using polysilsesquioxane as the second binder and by dispersing Y₃Al₅O₁₂ as a phosphor activated with Ce in the second binder. The thickness of the intermediate layer was 40 μm, and the thickness of the phosphor layer was 140 μm.

### Example 2

A phosphor wheel according to example 2 includes a substrate made of aluminum, an intermediate layer, and a phosphor layer, which are sequentially stacked on the substrate. The intermediate layer has a function as a reflection layer, and a phosphor layer. Example 2 was different from example 1 in that silicone resin was used as the first binder. The phosphor wheel was produced under the same conditions as in example 1 except for this.

### Comparative Example

A phosphor wheel according to a comparative example includes a substrate made of aluminum, an intermediate layer, and a phosphor layer, which are sequentially stacked on the substrate. The intermediate layer has a function as a reflection layer. The comparative example was different from example 1 in that silicone resin was used as the first binder and the second binder. The phosphor wheel was produced under the same conditions as in example 1 except for this.

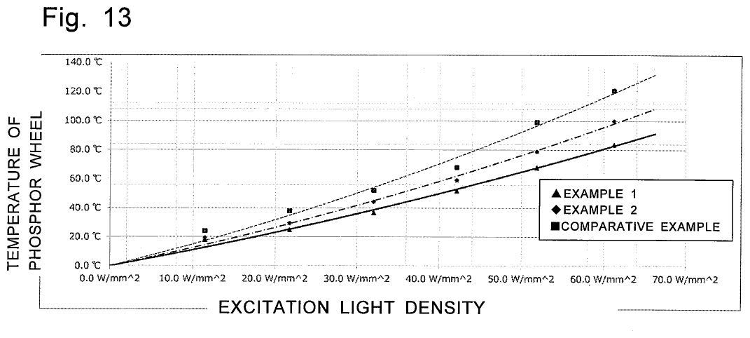

FIG. 13 is a graph showing a relationship between an excitation light density and a temperature of the phosphor wheel at the time of laser light irradiation from a laser light source in light source devices using phosphor wheels according to examples 1 and 2 of the first embodiment and the comparative example.

As shown in FIG. 13, the phosphor wheel according to example 2 in which silsesquioxane is used as the second binder has a temperature reduction effect of about 18% as compared with the case of using the phosphor wheel according to the comparative example in which silicone resin is used as the first binder and the second binder, under the irradiation condition where the excitation light density of the laser light source is 50 W/mm². Further, the phosphor wheel according to example 1 in which silsesquioxane is used as the first binder and the second binder has a temperature reduction effect of about 31% as compared with the case of using the phosphor wheel according to the comparative example, under the irradiation condition where the excitation light density of the laser light source is 50 W/mm².

Under the irradiation condition where the excitation light density of the laser light source is 30 W/mm², the phosphor wheel according to example 1 has a temperature reduction effect of about 28% as compared with the case of using the phosphor wheel according to the comparative example. The phosphor wheel according to example 2 has a temperature reduction effect of about 16% as compared with the case of using the phosphor wheel according to the comparative example.

### [1-2 Light Source Device]

Hereinafter, details of a light source device 11 using a phosphor wheel 10a according to modification 1 of the first embodiment will be described. The phosphor wheel 10a according to modification 1 used here is provided with an opening on a part of the circumference of substrate 1.

FIG. 9 is a diagram showing a configuration of the light source device 11 using the phosphor wheel 10a according to modification 1 of the first embodiment. Hereinafter, a description will be given using the phosphor wheel 10a according to modification 1 of the first embodiment shown in FIG. 1.

The laser light in the blue wavelength region emitted from a plurality of laser light sources 1101 is collimated by a plurality of collimator lenses 1102 provided corresponding to the laser light sources 1101. The collimated blue light enters a convex lens 1103 in the subsequent stage, the light flux width is reduced, and subsequently, the blue light enters into a diffusion plate 1104 and is diffused to improve its uniformity of light. The blue light with improved light uniformity enters a concave lens 1105 in the subsequent stage and is converted into a parallel light flux. The excitation light density of the laser light source 1101 may be, for example, 30 W/mm² or more, 50 W/mm² or more, or 100 W/mm² or more.

The blue light converted into a parallel light flux by the concave lens 1105 enters a color separating and combining mirror 1106 disposed at an angle of about 45 degrees with respect to the optical axis, changes its light traveling direction by 90 degrees, and enters a convex lens 1107 in the subsequent stage. The color separating and combining mirror 1106 has a spectral characteristic of reflecting light in the wavelength range of blue light emitted from the laser light source 1101 and causing light in the wavelength range of fluorescence obtained through wavelength conversion of blue light with the phosphor wheel 10a, the blue light as the excitation light emitted from laser light source 1101, to pass therethrough.

Here, the color separating and combining mirror 1106 has a spectral characteristic with a focus on the wavelength characteristics of the blue light from the laser light source and the wavelength-converted fluorescence. However, the color separating and combining mirror is not limited to this configuration, and for example, the color separating and combining mirror may have a spectral characteristic with a focus on the polarization and the wavelength. Specifically, focusing on the polarization direction of the laser light source, the polarization direction of the blue light from the laser light source may be adjusted to the same direction. As a result, a spectral characteristic with a focus on the polarization and the wavelength that reflects light in the blue wavelength range and the polarization direction from the laser light source and transmits light in the wavelength range of the wavelength-converted fluorescence may be provided.

The blue light that has entered the convex lens 1107 enters wavelength conversion layers 204a, 204b, 205a, and 205b on the same radius and openings 206a and 206b provided on the phosphor wheel 10a on the subsequent stage in combination with a convex lens 1108 on the subsequent stage.

The phosphor wheel 10a is provided with a motor 309. The motor 309 is disposed such that the blue excitation light condensed by the convex lenses 1107 and 1108 enters the same radial region from the rotation center where the wavelength conversion layers 204a, 204b, 205a, and 205b and the openings 206a and 206b are disposed around the rotation axis of the motor 309.

First, the blue light condensed on the wavelength conversion layers 204a, 204b, 205a, and 205b of the phosphor wheel 10a by the convex lenses 1107 and 1108 is wavelength-converted into fluorescence, changes its light traveling direction by 180 degrees, and enters the convex lenses 1108 and 1107 again in this order to be converted into a parallel light flux. The wavelength region of the fluorescence wavelength-converted by the phosphor wheel 10a is optimized so as to constitute, for example, white light in combination with the blue light emitted from the laser light source 1101.

The fluorescence emitted from the convex lens 1107 and converted into a parallel light flux enters the color separating and combining mirror 1106 again. As described above, the color separating and combining mirror 1106 has a characteristic of transmitting light in the wavelength region of fluorescence and is disposed at an angle of approximately 45 degrees with respect to the optical axis. Thus, the color separating and combining mirror transmits the fluorescence as it is without changing the traveling direction of the fluorescence.

Next, the blue light from the laser light source 1101 condensed in the openings 206a and 206b of the phosphor wheel 10a passes through the phosphor wheel 10a, and is converted into a parallel light flux by convex lenses 1121 and 1122 at the subsequent stage. Next, by a relay lens system including three mirrors 1123, 1125, and 1127 and three convex lenses 1124, 1126, and 1128 provided at the subsequent stage, the light is guided to the color separating and combining mirror 1106 so as to be converted into a parallel light flux and enter from a direction 180 degrees opposite to the direction in which the light from the laser light source 1101 enters the mirror.

Here, the relay optical system includes three mirrors and three convex lenses, but other configurations may be used as long as they have similar performance.

Since the color separating and combining mirror 1106 has a characteristic of reflecting the blue light from the laser light source 1101, the blue light that has entered the color separating and combining mirror 1106 from the convex lens 1128 is reflected by changing its light traveling direction by 90 degrees.

In this manner, according to the above configuration, the fluorescence and the blue light combined in a time division manner by the color separating and combining mirror 1106 enter a convex lens 1109 which is an optical system in the subsequent stage.

The time-division fluorescence and blue light that have entered the convex lens 1109 from the color separating and combining mirror 1106 are condensed in the vicinity of an incident end of a rod integrator 1111 described later by the convex lens 1109. The light emitted from the convex lens 1109 enters a wheel 1110 with a color filter before entering the rod integrator 1111. The wheel 1110 with a color filter is synchronized with the phosphor wheel 10a using a synchronization circuit (not shown) and includes a plurality of filters having spectral characteristics that allow transmission of a part or the entire wavelength range of the blue light and the fluorescence in accordance with the characteristics of the optical system.

The wheel 1110 with a color filter has a region that directly transmits the wavelength region of fluorescence with respect to yellow fluorescence from the phosphor wheel 10a, a region that directly transmits the wavelength region of fluorescence with respect to green fluorescence from the phosphor wheel 10a, a region that reflects light in the green wavelength region and transmits light in the ref wavelength region in fluorescence, and a region that directly transmits light in the blue wavelength region passing through the openings 206a and 206b from the phosphor wheel 10a. When the phosphor wheel 10a and the wheel 1110 with a color filter rotate in synchronization with each other, light beams having different wavelength ranges in time series are condensed in the vicinity of the incident end of the rod integrator 1111. The configuration of the wheel with a color filter is not limited to the above-described configuration, and it may be appropriately changed according to the specifications of the phosphor wheel, the light source device, and the projection-type image display apparatus.

The light beams having different wavelength ranges in time division that have entered the rod integrator 1111 are uniformized by the rod integrator and emitted from the emission end.

In the description of FIG. 9, the wheel 1110 with a color filter is disposed in the vicinity of the incident side of the rod integrator, but it may be disposed in the vicinity of the emission side.

### <Effects>

In the light source device 11 using the phosphor wheel 10a according to modification 1 of the first embodiment, the phosphor wheel 10a has excellent thermal conduction properties.

### [1-3 Projection-Type Image Display Apparatus]

Hereinafter, details of a projection-type image display apparatus 14 adopting the light source device 11 using the phosphor wheel 10a according to modification 1 of the first embodiment will be described.

FIG. 10 is a diagram showing a configuration of the projection-type image display apparatus 14 adopting the light source device 11 using the phosphor wheel 10a according to modification 1 of the first embodiment.

Since the configuration of the light source device 11 using the phosphor wheel 10a according to modification 1 of the first embodiment has been described above, the description thereof is omitted, and the behavior of the light after the light is emitted from the rod integrator 1111 will be described in detail.

The light emitted from the rod integrator 1111 is mapped to a DMD 1421 described later by a relay lens system including convex lenses 1401, 1402, and 1403.

The light transmitted through the convex lenses 1401, 1402, and 1403 and entered a total reflection prism 1411 enters a minute gap 1412 of the total reflection prism 1411 at the total reflection angle or an angle larger than the total reflection angle, and is reflected, whereby the traveling direction of the light is changed, and the light enters the DMD 1421.

The DMD 1421 changes the direction of a micromirror according to a signal from an image circuit (not shown) in synchronization with the color light emitted from a combination of the phosphor wheel 10a and the wheel 1110 with a color filter, changes the traveling direction of the light, and emits the light.

The light whose traveling direction has been changed by the DMD 1421 according to the image signal enters the minute gap 1412 of the total reflection prism 1411 at the total reflection angle or an angle smaller than the total reflection angle, is transmitted as it is, enters a projection lens 1431, and is projected on a screen (not shown).

### <Effects>

In the projection-type image display apparatus 14 using the light source device 11 using the phosphor wheel 10a according to modification 1 of the first embodiment, the phosphor wheel 10a has excellent thermal conduction properties.

### [2-2 Light Source Device]

Hereinafter, details of a light source device 12 of a second example using a phosphor wheel 10b according to modification 2 of the first embodiment will be described. In the phosphor wheel 10b according to modification 2 used here, a portion where only an intermediate layer having the function of a reflection layer is provided and no phosphor layer is provided is provided on a part of the circumference.

FIG. 11 is a diagram showing a configuration of the light source device 12 of the second example using the phosphor wheel 10b according to modification 2 the first embodiment. Hereinafter, a description will be given using the phosphor wheel 10b according to modification 2 of the first embodiment.

The laser light in the blue wavelength region emitted from a plurality of laser light sources 1201 is collimated by a plurality of collimator lenses 1202 provided corresponding to the laser light sources 1201. The collimated blue light is incident on a convex lens 1203 in the subsequent stage, the light flux width is reduced, and the blue light enters a subsequent diffusion plate 1204 and is diffused to improve its uniformity of light. The blue light whose light uniformity is improved in the diffusion plate 1204 enters a concave lens 1205 in the subsequent stage and is converted into a parallel light flux.

In a state where the light has been emitted from the concave lens 1205, the polarization direction of the laser light is adjusted by the optical system up to the concave lens 1205 so as to be S-polarized with respect to a polarization and color separating and combining mirror 1206 described later.

The blue light converted into a parallel light flux by the concave lens 1205 enters the polarization and color separating and combining mirror 1206 disposed at an angle of about 45 degrees with respect to the optical axis, changes its light traveling direction by 90 degrees, and enters a λ/4 waveplate 1207 in the subsequent stage. The polarization and color separating and combining mirror 1206 has a spectral characteristic of reflecting S-polarized light in the wavelength range of blue light emitted from the laser light source 1201 and causing P-polarized light in the blue wavelength range emitted from the laser light source 1201 and light in the wavelength range of fluorescence obtained through wavelength conversion of blue light with the phosphor wheel 10b described later, the blue light as the excitation light emitted from the laser light source 1201, to pass therethrough.

The polarization direction of the blue light from the laser light source 1201 that has entered the λ/4 waveplate 1207 is rotated, and the light is changed to circularly polarized light.

The light that has entered the λ/4 waveplate 1207 enters a convex lens 1208, then enters reflection regions 213a and 213b and the wavelength conversion layers 204a, 204b, 205a, and 205b provided in the phosphor wheel 10b on the subsequent stage in combination with a convex lens 1209 on the subsequent stage. The phosphor wheel 10b is provided with a motor 409. The motor is provided such that the blue excitation light condensed by the convex lenses 1208 and 1209 enters the reflection regions 213a and 213b and the wavelength conversion layers 204a, 204b, 205a, 205b around the rotation axis of the motor.

First, the blue light condensed on the wavelength conversion layers 204a, 204b, 205a, and 205b of the phosphor wheel 10b by the convex lenses 1208 and 1209 is converted into fluorescence, changes its light traveling direction by 180 degrees, and enters the convex lenses 1209 and 1208 again in this order to be converted into a parallel light flux. Each wavelength region of the fluorescence wavelength-converted by the phosphor wheel 10b is optimized so as to constitute white light in combination with the blue light emitted from the laser light source 1201.

The fluorescence converted into a parallel light flux by the convex lens 1208 and emitted passes through the λ/4 waveplate 1207 and enters again the polarization and color separating and combining mirror 1206 disposed at an angle of 45 degrees with respect to the optical axis. As described above, the polarization and color separating and combining mirror 1206 has a characteristic of transmitting the light in the wavelength region of fluorescence. Thus, the fluorescence is allowed to pass as it is without changing the direction of the light, and the fluorescence enters a convex lens 1210 in the subsequent stage.

Next, the blue light from the laser light source 1201 condensed on the reflection regions 213a and 213b of the phosphor wheel 10b is reflected on the reflection regions 213a and 213b of the phosphor wheel 10b, changes its light traveling direction by 180 degrees, and enters the convex lenses 1209 and 1208 in this order to be converted into a parallel light flux.

The blue light converted into a parallel light flux by the convex lenses 1209 and 1208 enters the λ/4 waveplate 1207 at the subsequent stage, rotating its polarization direction, is converted into P-polarized light, and is emitted.

The P-polarized light in the blue wavelength region emitted from the λ/4 waveplate 1207 enters the polarization and color separating and combining mirror 1206 disposed at an angle of approximately 45 degrees with respect to the optical axis. The polarization and color separating and combining mirror 1206 has a characteristic of reflecting S-polarized light in the blue wavelength range emitted from the laser light source 1201 and transmitting P-polarized light in the blue wavelength range emitted from the laser light source 1201 and light in the wavelength range of fluorescence obtained through wavelength conversion with the phosphor wheel 10b. Thus, the P-polarized light in the blue wavelength region emitted from the λ/4 waveplate 1207 passes as it is without changing its light traveling direction, and enters the convex lens 1210 in the subsequent stage.

The fluorescence and the blue light enter the convex lens 1210 in time series according to the rotation of the phosphor wheel 10b and are condensed in the vicinity of the incident end of a rod integrator 1212 described later. The light condensed by the convex lens 1210 enters a wheel 1211 with a color filter. The wheel 1211 with a color filter has the same configuration as that of the wheel 1211 with a color filter adopted in the light source device 11 adopting the phosphor wheel according to modification 1 of the first embodiment. When the phosphor wheel 10b and the wheel 1211 with a color filter rotate in synchronization with each other, light beams having different wavelength ranges is condensed in time series in the vicinity of the incident end of the rod integrator 1212.

The light beams having different wavelength ranges in time division that have entered the rod integrator 1212 are uniformized by the rod integrator and emitted from the emission end.

In the description of FIG. 9, the wheel 1211 with a color filter is disposed in the vicinity of the incident side of the rod integrator, but it may be disposed in the vicinity of the emission side.

### <Effects>

In the light source device 12 using the phosphor wheel 10b according to modification 2 of the first embodiment, the phosphor wheel 10b has excellent thermal conduction properties.

### [2-3 Projection-Type Image Display Apparatus]

Hereinafter, details of a projection-type image display apparatus 15 adopting the light source device 12 using the phosphor wheel 10b according to modification 2 of the first embodiment will be described.

FIG. 10 is a diagram showing a configuration of the projection-type image display apparatus 15 adopting the light source device 12 using the phosphor wheel 10b according to modification 2 of the first embodiment.

Since the configuration of the light source device 12 using the phosphor wheel 10b according to modification 2 of the first embodiment has been described above, the description thereof is omitted here. In addition, the behavior of the light after the light is emitted from the rod integrator 1212 is substantially the same as the behavior of the light after the light is emitted from the rod integrator 1010 described with reference to FIG. 7, and thus the description thereof is omitted here.

### <Effects>

In the projection-type image display apparatus 15 using the light source device 12 using the phosphor wheel 10b according to modification 2 of the first embodiment, the phosphor wheel 10b has excellent thermal conduction properties.

The present disclosure includes appropriate combination of any embodiments and examples among the various embodiments and examples described above, and effects of the respective embodiments and examples can be exhibited.

The phosphor wheel according to the present disclosure includes a binder having excellent thermal conduction properties, and thus is useful as a phosphor wheel for high output.

### REFERENCE SIGNS LIST

1 substrate
2 intermediate layer (reflection layer)
3 phosphor layer
4 motor mounting hole
6 motor
10, 10a, 10b phosphor wheel
11 light source device
1101 laser light source
1102 collimator lens
1103 convex lens
1104 diffusion plate
1105 concave lens
1106 color separating and combining mirror
1107 convex lens
1108 convex lens
309 motor
1109 convex lens
1110 wheel with color filter
1111 rod integrator
1121 convex lens
1122 convex lens
1123 mirror
1124 convex lens
1125 mirror
1126 convex lens
1127 mirror
1128 convex lens
12 light source device
1201 laser light source
1202 collimator lens
1203 convex lens
1204 diffusion plate
1205 concave lens
1206 polarization and color separating and combining mirror
1207 λ/4 waveplate
1208 convex lens
1209 convex lens
409 motor
1210 convex lens
1211 wheel with color filter
1212 rod integrator
14 projection-type image display apparatus
1401 convex lens (relay lens)
1402 convex lens (relay lens)
1403 convex lens (relay lens)
1411 total reflection prism
1412 minute gap
1421 DMD
1431 projection lens
15 projection-type image display apparatus
1501 relay lens
1502 relay lens
1503 relay lens
1511 total reflection prism
1512 minute gap
1521 DMD
1531 projection lens

1. A phosphor wheel comprising:
a substrate;
an intermediate layer provided on the substrate, the intermediate layer being made of a first binder; and
a phosphor layer provided on the intermediate layer, the phosphor layer comprising a second binder and a phosphor included in the second binder,
wherein at least one of the first binder and the second binder contains polysilsesquioxane.

2. The phosphor wheel according to claim 1, wherein
the first binder contains silicone resin, and
the second binder contains polysilsesquioxane.

3. The phosphor wheel according to claim 1, wherein the first binder or the second binder containing the polysilsesquioxane contains an organosilicon compound having a reactive bifunctional group in an amount of 50 wt % or less with respect to 100 wt % of the polysilsesquioxane contained in the first binder or the second binder.

4. The phosphor wheel according to claim 3, wherein the first binder or the second binder containing the polysilsesquioxane contains the organosilicon compound having a reactive bifunctional group in an amount of 30 wt % or less with respect to 100 wt % of the polysilsesquioxane contained in the first binder or the second binder.

5. The phosphor wheel according to claim 1, wherein
the second binder contains polysilsesquioxane, and
the first binder contains polysilsesquioxane and an organosilicon compound having a reactive bifunctional group in an amount of 50 wt % or less with respect to 100 wt % of the polysilsesquioxane contained in the first binder and the second binder.

6. The phosphor wheel according to claim 1, wherein
the second binder contains polysilsesquioxane, and
the first binder contains polysilsesquioxane and an organosilicon compound having a reactive bifunctional group in an amount of 30 wt % or less with respect to 100 wt % of the polysilsesquioxane contained in the first binder and the second binder.

7. The phosphor wheel according to claim 1, wherein the first binder and the second binder contain polysilsesquioxane.

8. A light source device including the phosphor wheel according to claim 1.

9. The light source device according to claim 8, comprising a laser light source having an excitation light density of 30 W/mm² or more.

10. A projection-type image display device including the light source device according to claim 8.

11. A method for producing a phosphor wheel, the method comprising:
providing a substrate;
providing an intermediate layer made of a first binder on the substrate; and
providing a phosphor layer comprising a second binder and a phosphor included in the second binder on the intermediate layer,
wherein at least one of the first binder and the second binder contains polysilsesquioxane.
